(19) United States
(12) Patent Application Publication
(10) Pub. No.: US 2018/0315270 A1
(43) Pub. Date: Nov. 1, 2018

(54) Vending Machine

(71) Applicant: Taylor Rosenthal, Opelika, AL (US)

(72) Inventor: Taylor Rosenthal, Opelika, AL (US)

(21) Appl. No.: 15/498,049

(22) Filed: Apr. 26, 2017

(51) Int. Cl. G07F 11/72; G07F 11/52; G07F 7/08; G07F 7/04; G06Q 20/34

(52) U.S. Cl. CPC G07F 11/72; G07F 11/52; G06Q 20/34; G07F 7/04; G07F 7/0873

(57) ABSTRACT

A vending machine for vending packaged products having a product compartment, a plurality of delivery arms located in the product compartment, each including a moveable endless chain having a plurality of product hooks. By allowing retention of a product from the top of a package or product, or through the use of a hook retention system, the present invention allows for a larger capacity than current vending machines.

### BACKGROUND OF INVENTION

### Field of the Invention

This invention relates to vending machines, and more particularly to a vending machine capable of having an increased inventory delivery system.

### The Prior Art

A vending machine is a machine that provides consumers with various goods, most commonly seen in the form of beverages, snacks, and other products without a physical cashier. These machines have evolved over time, moving from coin operation and push button mechanics to credit/debit card readers and touch screens. Although the exterior of traditional vending machines have undergone several modifications, the inner-workings of the method of dispensing have not. Many modern vending machines still utilize a coil-vending system, which normally have motor-driven coil systems, either singular or dual, that, through its rotation, pushes an item forward. Although this method has been widely-popular, it has several shortcomings. The most important, is inventory capacity. Many traditional snack vending machines can only hold up to five-hundred items at maximum capacity. This is largely due to the fact that the coil-vending system requires large spacing between products. Additionally, it places a large burden on restocking, since a specific product orientation must be implemented to prevent improper dispensing. Lastly, when vending products, there is a need to bag multiple items in order for customers to securely carry all of their products from the vending machine.

U.S. Pat. No. 3,780,909 to Callahan et al. discloses a vending machine for vending packaged products that uses a plurality of delivery arms along a chain having a plurality of pairs of package retention elements that dispense products.

U.S. Pat. No. 2010/0268792 A1 to Butler et al. discloses a system and method for implementing an interactive display, including advertisements, to vend various products.

The disadvantage of traditional vending machines is that their method of dispensing is not efficient in terms of inventory capacity. Additionally, other modes of dispensing products have not proved to be worthwhile in replacing the traditional coil-vending system. U.S. Pat. No. 3,780,909 to Callahan et al. attempts to utilize pairs of package retention elements, however, this method takes up a lot of pertinent space within the storage compartment of that vending machine. This has left a need for a new system of vending products that can hold a much larger amount of inventory, allowing less restocking time and through that, greater savings for owners of vending machines. This new system of vending products can incorporate the latest technology disclosed in U.S. Pat. No. 2010/0268792 of an interactive touch screen and communications system, allowing for a new vending machine, with the latest incorporated technology.

### SUMMARY OF THE INVENTION

It is an object of the present invention to provide an improved dispensing system for product vending machines that allows a much higher volume of inventory.

These and other objects are accomplished by a vending machine able to have a maximum inventory capacity much greater than traditional vending machines. The vending machine of the present invention consists essentially of an enclosure, a plurality of delivery arms located in the product compartment, each including a moveable endless tread having a plurality of product hooks that can hold an item. The delivery arm is comprised of a tread-like pattern, each having a product hook, wrapped around at least one wheel. Although this requires that packaging be perforated, many companies perform this function already to easily hang on the racks of most convenience and department stores. It is important to note that the retention method for the present invention involves holding the product from the top of its package or body. Additionally, many products are fitted with hooks for this same purpose, both of which can be implemented in the present invention. Utilizing this system, in order to vend a product, the gear(s) rotates only to move one product hook from the front position over a corner. Due to the angle of the product hook after this rotation, in addition to gravity, the product drops towards a location where a consumer can retrieve it. Furthermore, each delivery arm is able to be moved along both the x and y-axis of the vending machine, through grooved fittings that can allow complete customization. One additional design element is that these dispenser arms can slide in and out of the vending machine, which will make restocking it much easier in tandem with not having to restock the machine as often as traditional vending machines.

### BRIEF DESCRIPTION OF THE DRAWINGS

FIG. 1 is a perspective view of one embodiment of the improved vending machine of this invention.

FIG. 2 is a perspective view of one embodiment of the dispensing system of this invention.

FIG. 3 is a side-view of one embodiment of the dispensing system of this invention.

FIG. 4 is a front view of one embodiment of the inside of the improved vending machine of this invention with the door removed.

### DETAILED DESCRIPTION OF THE INVENTION

It is to be understood that the following disclosure provides different embodiments, or examples, for implementing different features of various embodiments of the invention. Specific examples of components and arrangements are described below. These are merely examples and are not intended to be limiting. In addition, the present disclosure may repeat reference numerals and/or letters in the various examples. This repetition is for the purpose of simplicity. Hereinafter, an exemplary embodiment of the present disclosure will be discussed in reference to the drawings.

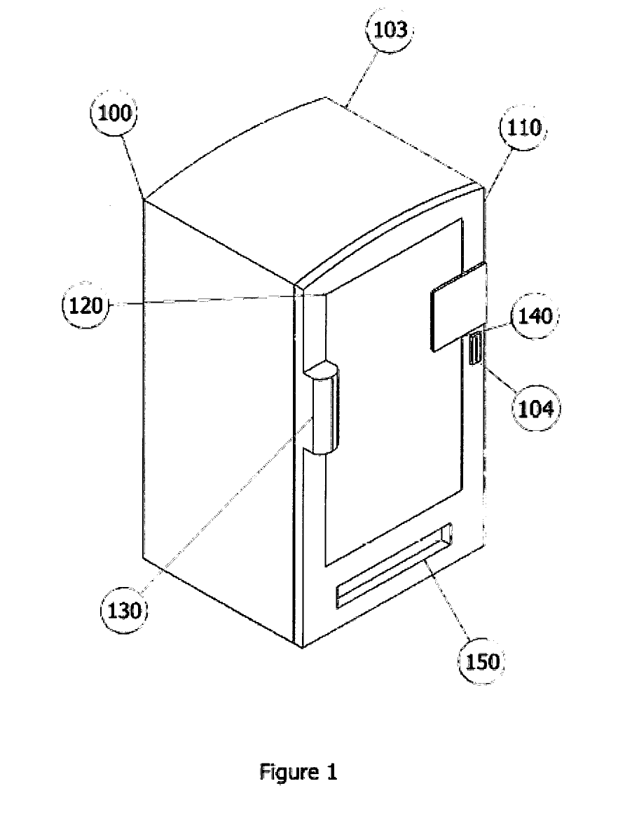

The improved vending machine 100 of this invention is illustrated in FIG. 1. FIG. 1 is a perspective view of one embodiment of the present invention. Shell 103 provides the housing for the product compartment, product dispensers, and an optional bagging system. Door 110 is attached to shell 103 that can allow access for modifications, restocking, or any other incidental need that requires work on the interior of improved vending machine 100. Fixedly attached to door 110 is a means for a touch-screen 140. This will allow customers to easily choose which products they desire, along with providing a means for a credit/debit card reader 104. Additionally, this may require a means to read personal identification and driver's licenses in case at least one of the products requires a statutory minimum age required by law. Integrated into door 110 is transparent panel 120. This will allow potential customers to see the actual contents from outside improved vending machine 100. The selections will also be readily visible in touch-screen 140. Normally, vending machines target consumers to purchase a single product, whether it be a beverage or snack, however they have evolved to carry products outside of consumables. Because of this, bag retrieval 130 can be implemented that contains a means for dispensing single bags so that customers have the ability to bag multiple product selections. Improved vending machine 100 also contains an item retrieval compartment 150, where consumers can collect their vended items. This may either be a space where a user can reach their hand through and collect said items, or have a rotating door that allows the same.

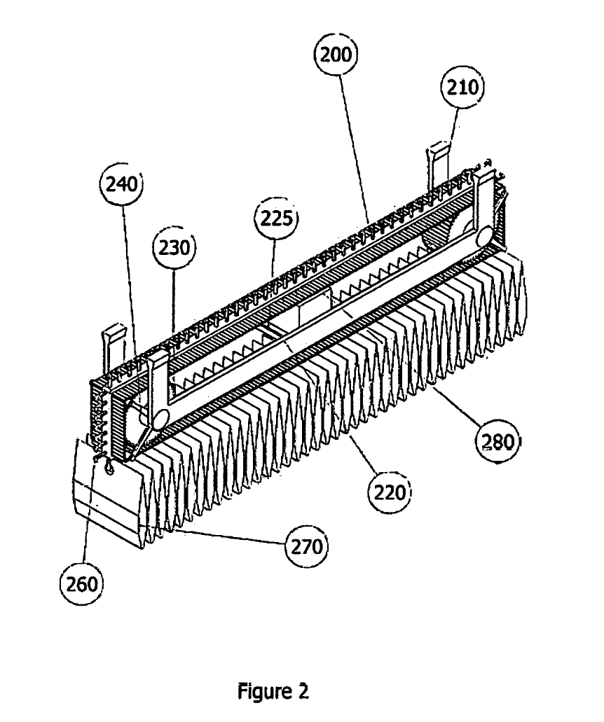

FIG. 2 is a perspective view of one embodiment of the dispensing system of the present invention. In essence, the dispensing system of the present invention consists of a plurality of delivery arms located within the product compartment, each including a moveable, endless tread having a plurality of product hooks that can hold an item. The moveable, endless chain moves along at least one rotating wheel that latches onto the treads in at least one point. In order to dispense, a means for turning is implemented to rotate slightly in order to move the most forward hook over the corner of the front face, causing the product to drop. FIG. 2 depicts one embodiment of the dispensing system described above. Track 200 in one embodiment is made of a plurality of rectangular plates that are linked together, each containing one hook 260. Each hook 260 can hold one product 270, preferably bagged. Track 200 is then wrapped around at least two gears 230 that insert into the spacing between track 200. The two gears 230 are at a fixed distance, attached to two connecting bars 220. Connecting bars 220 provides structural support for the dispensing system. Additionally, rollers 240 are implemented, attaching to connecting bars 220 and touching track 200 in order to create a rectangular shape that assists in vending products. Connecting bars 220 also have connection piece 210 attached to it at four difference places, allowing it to slide into improved vending machine 100. As will be discussed later, improved vending machine 100 allows owners the ability to fully customize the space in both the x and y-axis, allowing the ability to vend abnormally shaped products. Gears 230 are powered through a motor 280 that interacts with improved vending machine 100 and activates to dispense a selected product. Connecting table 225 connects the two connecting bars 220 and also acts as a platform for the motor to be attached to.

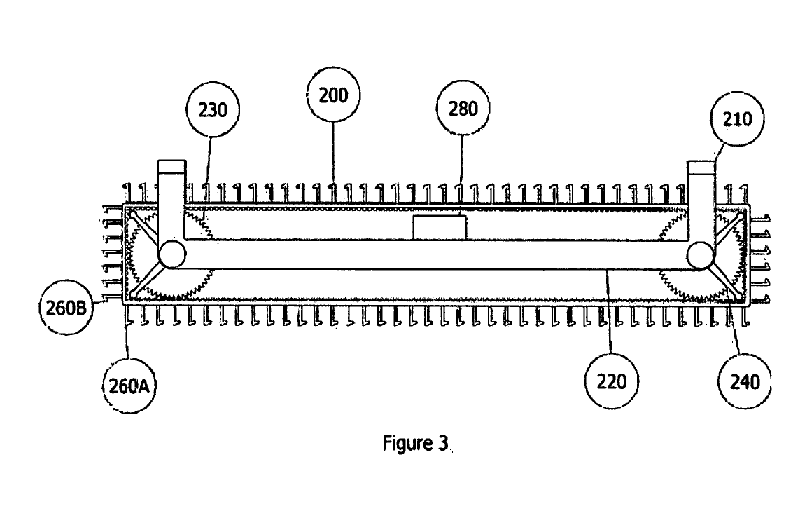

FIG. 3 is a side-view of one embodiment of the dispensing system of this invention. FIG. 3 is meant to provide the examiner with a clearer picture of the dispensing process. When a product is selected and proper payment has been received, the motor 280, in communication with the touch-screen 140, will vend that product. Hook 260A, before the item is vended, is in the most forward position along the delivery arm. In order to vend, gears 230 rotate, causing hook 260A to transition to the hook 260B position. When this occurs, due to the perforation in the product, the product will drop due to gravity and arrive in the item retrieval compartment 150. It is important to note that hook 260 is preferably angled at approximately 60 degrees in order to prevent items from falling incidentally, or if the entire vending machine is shaken.

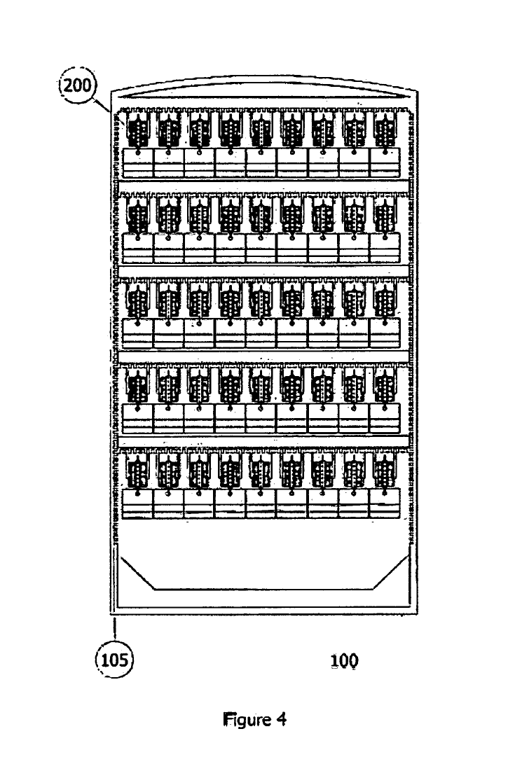

FIG. 4 is a front view of one embodiment of the inside of the improved vending machine of this invention with the door removed. The inventory efficiency of improved vending machine 100 is most readily apparent from this view. As shown, the delivery arms are compact and to-scale, approximately nine delivery arms are able to fit on a single row using the dimensions of the average vending machine. Furthermore, five columns of nine delivery arms are able to be fit in a traditional vending casing. Depending on the size of the product, approximately forty products are able to fit on a single delivery arm, resulting in a potential capacity of almost two-thousand products. By this design, owners of vending machines can hold more products and spend less on restocking costs. As exemplified in FIG. 4, the inside perimeter of the improved vending machine 100 is outfitted with a groove system 105. This allows for a fully customizable vending machine. Dispenser holders 290 can be placed anywhere along the y-axis of the vending machine. Each dispenser holder 290 also includes groove system 105. Additionally, dispenser holder 290 has a three-dimensional triangular shape that creates an incline so that products vended come in contact with it and slide off, preventing the products from getting stuck in lower delivery arms. This means the individual delivery arms can be positions in any fashion along the x-axis of the dispenser holder 290. This modification was created in order to dispense various sizes and shapes of products without having to create a new machine entirely.

What is claimed is:

1. A vending machine for vending products having at least one delivery arm for retaining and dispensing packages, wherein said delivery arm comprising:
a. a moveable endless tread having a plurality of product hooks;
b. at least one gear rotatively connected to the moveable endless tread;
c. at least one support bar system fixedly attached to at least one gear;
d. at least one set of rollers fixedly attached to at least one year.

2. The vending machine of claim 1, further comprising a bag dispenser for manual bagging by the user.

3. The vending machine of claim 1, further comprising a touch-screen for product selection.

4. The vending machine of claim 1, further comprising a card reader to read electronic payment and personal identification.

5. The vending machine of claim 1, further comprising a means to accept cash payment.

6. The vending machine of claim 1, further comprising of a bagging process, wherein said bagging process comprising:
a. a product container to hold vended products;
b. an actuator to push said vended products;
c. a moveable suction device to retrieve a bag;
d. a container to hold a plurality of bags.

7. The vending machine of claim 6, further comprising a touch-screen for product selection.

8. The vending machine of claim 6, further comprising a card reader to read electronic payment and personal identification.

9. The vending machine of claim 6, further comprising a means to accept cash payment.
